(19) United States
(12) Patent Application Publication
(10) Pub. No.: US 2017/0032340 A1
(43) Pub. Date: Feb. 2, 2017

(54) TRANSACTION PLATFORM OF VIRTUAL COMMODITIES

(71) Applicant: Tien-Shu HSU, Taichung (TW)

(72) Inventor: Tien-Shu HSU, Taichung (TW)

(21) Appl. No.: 15/304,289

(22) PCT Filed: May 7, 2014
(86) PCT No.: PCT/CN2014/076987

§ 371 Date: Oct. 14, 2016

(51) Int. Cl. G06Q 20/10; G06Q 20/34; G06Q 30/06; G06Q 20/40

(52) U.S. Cl. CPC G06Q 20/102; G06Q 20/401; G06Q 20/341; G06Q 30/0641

(57) ABSTRACT

A transaction platform of virtual commodities includes a transaction processing component, a commodities verified component and a payment verified component. The transaction processing component establishes a trade target appended with a transaction condition on the transaction platform of virtual commodities for a virtual commodity in a game system. The commodities verified component generates and transmits a seizure signal to the game system, to cause the game system check the authenticity of the virtual commodity and seizure the virtual commodity. When a buyer performs a transaction on the trade target, the payment verified component verifies whether the buyer has fulfilled the transaction condition, and immediately notifies the game system to hand over the corresponding virtual commodity to the buyer once the buyer has fulfilled the transaction condition. Thus, the buyer is able to obtain the ownership of the virtual commodity immediately after having fulfilled the transaction condition.

### FIELD OF THE INVENTION

The present invention relates to electronic commerce (e-commerce), and particularly to a transaction platform of virtual commodities of e-commerce.

### BACKGROUND OF THE INVENTION

An online game is a game that is together played by a plurality of players connected to a game system by the Internet. Unbound by distance and language and providing most realistic interactions, online games are popular among players and have gradually become the mainstream of the game market.

When an online game is played, virtual gears, treasures, gadgets or money exclusive for the game system may be traded, exchanged and used. To meet playing requirements of different players, there are often exchange and transaction needs. A conventional transaction method largely involves two approaches—official transactions and private transactions. The official transaction, quite self-explanatory, allows transactions through a transaction platform that the game system provides, so that different users may conduct transactions through this transaction platform. In general, an official transaction is safe. However, the official transaction is limited to exchanges of virtual gears, treasures, gadgets and virtual money used in the game system, and has a quite broad limitation that may not satisfy transaction needs of players.

A private transaction is a transaction conducted using a transaction platform that is not provided by the game system. In addition to personal hawking transactions of players, private transactions also include those conducted using a platform that is not provided by the game system, e.g., an auction website. Given that no illegal transactions and behaviors are involved, players may obtain what is needed and freely sell as desired; for example, trading virtual gears, treasures, gadgets and virtual money for real money, and vice versa.

However, private transactions suffer from a security issue. Thus, to ensure transaction security of buyers, e.g., on a transaction platform such as an auction website, the identification of sellers usually needs to be verified to make sure that commodities sold by the sellers are not only present but also legitimate. Further, a refund service is provided to buyers in the event of an unsuccessful transaction. In order to safeguard the transaction security of buyers, when a buyer intends to buy a virtual commodity and makes a requested payment, a seller only transfers the ownership of the virtual commodity to the buyer once the seller confirms that the payment from the buyer is received, hence guaranteeing the security of the seller. Thus, the buyer cannot obtain the virtual commodity immediately after having made the payment.

For a popular online game, the value of a virtual commodity may drastically fluctuate with time, and usually depreciates as time goes by. When a buyer is unable to obtain the virtual commodity right after paying for it, the time value lost is usually difficult to estimate. Thus, to obtain the required virtual commodity immediately after it has been paid for, one may accept a personal hawking transaction method that is not safeguarded at all from a seller. Such personal hawking transaction method from a seller is one main cause of persistently occurring fraudulent transactions. It is apparent that conventional transaction methods of virtual commodities fall short in satisfying utilization requirements.

### SUMMARY OF THE INVENTION

Therefore, it is a primary object of the present invention to disclose a transaction platform of virtual commodities. In addition to ensure transaction security of buyers and sellers, the present invention further allows a buyer to obtain a virtual commodity immediately after having paid for the virtual commodity to satisfy transaction needs.

To achieve the above object, the present invention provides a transaction platform of virtual commodities. The transaction platform is connected to a financial system and a game system, and includes a transaction processing component, a commodities verified component, and a payment verified component. The transaction processing component allows a seller to establish a trade target appended with a transaction condition on the transaction platform for a virtual commodity in the game system, and allows a buyer to perform a transaction on the trade target by fulfilling the transaction condition. The commodities verified component generates and transmits a seizure signal to the game system, to cause the game system to check the authenticity of the virtual commodity, seizure the virtual commodity, and return a seizure complete signal to the commodities verified component to complete the verification process of the trade target. Further, when the buyer performs the transaction on the trade target, the payment verified component verifies whether the buyer has fulfilled the transaction condition, and immediately notifies the game system once the buyer has fulfilled the transaction condition to hand over the corresponding virtual commodity to the buyer.

Accordingly, in the present invention, the commodities verified component generates and transmits the seizure signal to the game system to cause the game system to check the authenticity of the virtual commodity and seizure the virtual commodity. Once the buyer has fulfilled the transaction condition, the payment verified component immediately notifies the game system to hand over the corresponding virtual commodity to the buyer. Thus, after having fulfilled the transaction condition, the buyer is able to immediately obtain the virtual commodity, hence maintaining the time value of the virtual commodity and satisfying transaction needs.

### BRIEF DESCRIPTION OF THE DRAWINGS

FIG. 1 is a structural diagram of a system of the present invention; and

FIG. 2 is another structural diagram of a system of the present invention.

### DETAILED DESCRIPTION OF THE PREFERRED EMBODIMENTS

Details and technical contents of the present invention are given in the embodiments with the accompanying drawings below. It should be noted that, these embodiments are for illustrations and are not to be construed as limitations to the present invention.

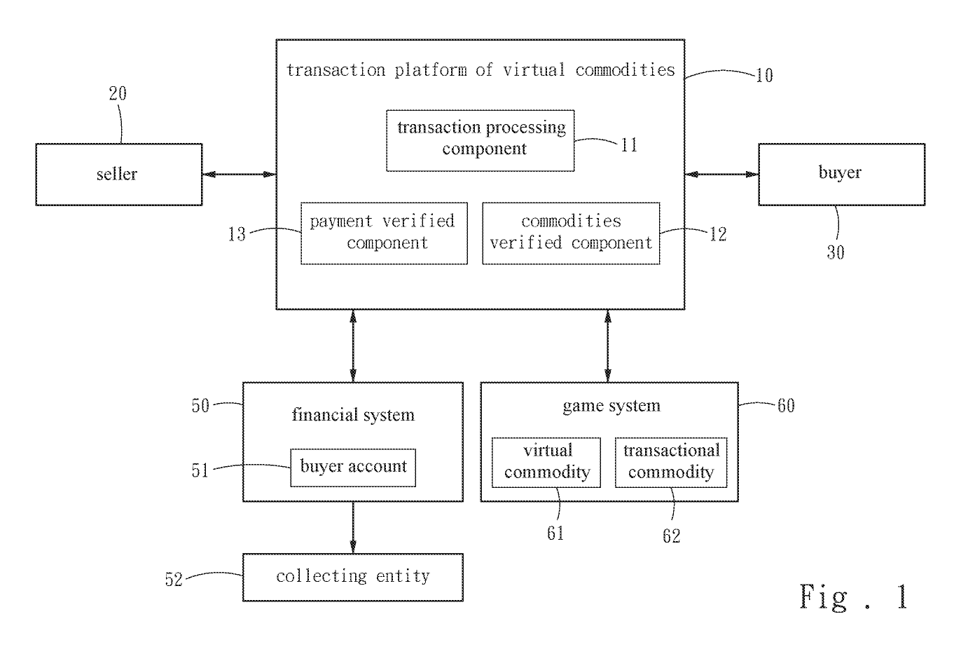

Referring to FIG. 1, the present invention provides a transaction platform 10 of virtual commodities. The transaction platform 10 of virtual commodities, connected to a financial system 50 and a game system 60, includes a transaction processing component 11, a commodities verified component 12 and a payment verified component 13. The transaction processing component 11 allows a seller 20 to establish a trade target appended with a transaction condition on the transaction platform 10 of virtual commodities for a virtual commodity 61 in the game system 60, and allows a buyer 30 to fulfill the transaction condition to perform a transaction on the trade target.

After the seller 20 establishes the trade target, the commodities verified component 12 generates and transmits a seizure signal to the game system 60, to cause the game system 60 to check the authenticity of the virtual commodity 61, seizure the virtual commodity 61, and return a seizure complete signal to the commodities verified component 12, hence completing the verification process of the trade target.

When the buyer 30 performs the transaction on the trade target, the payment verified component 13 verifies whether the buyer 30 has fulfilled the transaction condition, and immediately notifies the game system 60 once the buyer 30 has fulfilled the transaction condition, so as to hand over the virtual commodity 61 to the buyer 30.

Several non-limiting common transaction modes are listed below.

### First Embodiment

Assume that the transaction condition is that the buyer 30 makes a transaction payment in the financial system 50. That is, the buyer 30 purchases the virtual commodity 61 with real money, and may use the financial system 50 to make the transaction payment. Upon receiving the transaction payment, the financial system 50 transmits a payment complete signal to the payment verified component 13 to verify that the buyer 30 has fulfilled the transaction condition. Thus, the payment verified component 13 immediately notifies the game system 60 to hand over the corresponding virtual commodity 61 to the buyer 30.

How the financial system 50 makes the transaction payment may be categorized into following scenarios. First, when the buyer 30 performs the transaction on the trade target, the transaction processing component 11 may notify the financial system 50 to generate a virtual account, to which the buyer 30 may remit the transaction payment through ATM or counter remittance, such that the financial system 50 may receive the transaction payment.

Alternatively, assume that the buyer 30 has a buyer account 51 in the financial system 50. When the buyer 30 performs the transaction on the trade target, the buyer 30 may authorize the transaction processing component 11 to notify the financial system 50 to deduct the transaction payment from the buyer account 51, such that the financial system 50 is allowed to receive the transaction payment.

Alternatively, when the buyer 30 performs the transaction on the trade target, the transaction processing component 11 may notify the financial system 50 to perform a credit card payment process. Thus, the transaction processing component 11 generates an online credit card authorization webpage to prompt the buyer 30 to directly enter credit information online using the credit card payment process, such that the financial system 50 is allowed to receive the transaction payment.

Alternatively, the transaction processing component 11 may notify the financial system 50 to generate a collection barcode at a collecting entity 52, which is, for example, a convenience store, a post office or a financial organization. The buyer 30 may then head for the above locations and make the transaction payment through the collection barcode at the collecting entity 52, such that the financial system 50 is able to receive the transaction payment.

### Second Embodiment

Assume that the transaction condition is that the buyer 30 pays a transactional commodity 62 in the game system 60 to the seller 20; that is, the buyer 30 exchanges a virtual commodity for another virtual commodity. At this point, once the game system 60 hands over the transactional commodity 62 to the seller 20, it is regarded that the transaction condition is fulfilled, and meanwhile the game system 60 hands over the virtual commodity 61 to the buyer 30.

Regarding operation details, the transactional commodity 62 and the virtual commodity 61 may be from the same game system or from different game systems, with the two situations described in detail below.

As shown in FIG. 1, if the transactional commodity 62 and the virtual commodity 61 are from the same game system 60, the buyer 30 transmits a transaction signal to the game system 60 through the payment verified component 13, so as to have the game system 60 hand over the transactional commodity 62 to the seller 20 to fulfill the transaction condition.

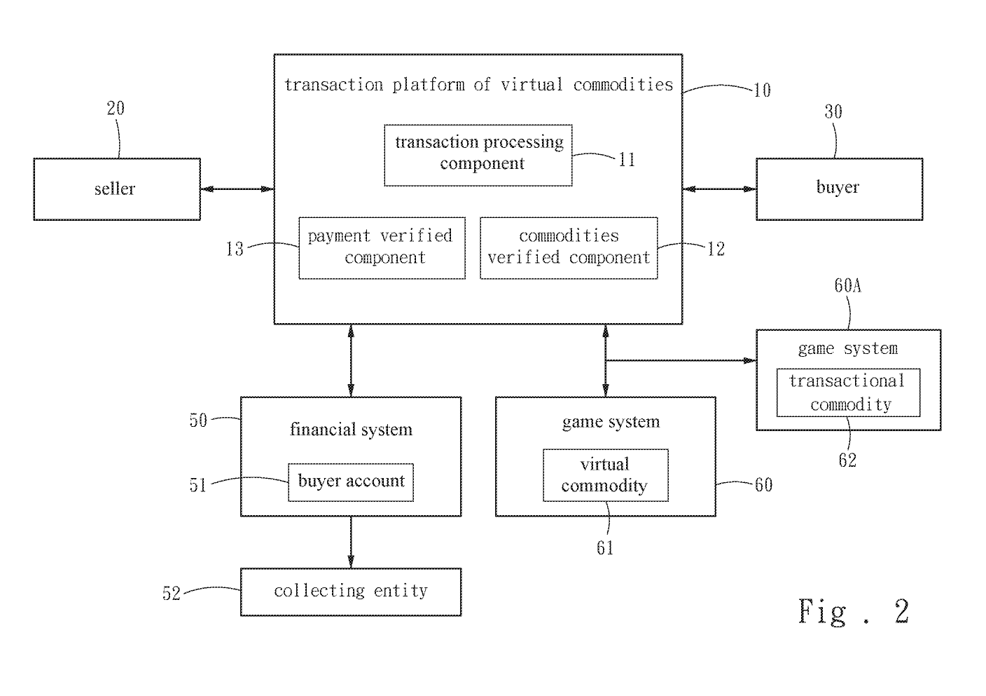

Referring to FIG. 2, if the transaction condition is that the buyer 30 pays a transactional commodity 62 from another game system 60A to the seller 20, it means that the virtual commodity 61 and the transactional commodity 62 are from different game systems 60A and 60. Thus, when the transactional commodity 62 of the another game system 60A is handed over to the seller 20, it is regarded that the transaction condition is fulfilled, and meanwhile the game system 60 hands over the virtual commodity 61 to the buyer 30. Further, the buyer 30 transmits a transaction signal to the another game system 60A through the payment verified component 13, so as to have the another game system 60A hand over the transactional commodity 62 to the seller 20.

As described, in the present invention, the commodities verified component generates the seizure signal to the game system, which is then caused to check the authenticity of the virtual commodity and seizure the virtual commodity, hence ensuring the presence of the virtual commodity. Further, once the buyer fulfills the transaction condition, the payment verified component immediately notifies the game system to hand over the corresponding virtual commodity to the buyer. Thus, after having fulfilled the transaction condition, the buyer is allowed to immediately obtain the virtual commodity to maintain the time value of the virtual commodity. In addition to ensuring the transaction security of both the buyer and seller, the buyer is able to obtain the virtual commodity once having paid for the virtual commodity, thereby satisfying transaction needs.

What is claimed is:

1. A transaction platform for virtual commodities, connected to a financial system and a game system, comprising:
a transaction processing component, for a seller to establish a trade target appended with a transaction condition on the transaction platform of virtual commodities for a virtual commodity in the game system, and for a buyer to fulfill the transaction condition to perform a transaction on the trade target;
a commodities verified component, generating and transmitting a seizure signal to the game system after the seller establishes the trade target, to cause the game system to check authenticity of the virtual commodity, seizure the virtual commodity, and return a seizure complete signal to the commodities verified component to complete a verification process of the trade target; and
a payment verified component, verifying whether the buyer has fulfilled the transaction condition when the buyer performs the transaction on the trade target, and immediately notifying the game system once the buyer has fulfilled the transaction condition to hand over the corresponding virtual commodity to the buyer.

2. The transaction platform for virtual commodities of claim 1, being characterized that, the transaction condition is that the buyer makes a transaction payment at the financial system, and the financial system transmits a payment complete signal to the payment verified component once the financial system receives the transaction payment to verify that the buyer has fulfilled the transaction condition.

3. The transaction platform for virtual commodities of claim 2, being characterized that, the transaction processing component notifies the financial system to generate a virtual account when the buyer performs the transaction on the trade target, and the buyer remits the transaction payment to the virtual account to have the financial system receive the transaction payment.

4. The transaction platform for virtual commodities of claim 2, being characterized that, the buyer has a buyer account in the financial system, and the buyer authorizes the transaction processing component to notify the financial system to deduct the transaction payment from the buyer account when the buyer performs the transaction on the trade target to have the financial system to receive the transaction payment.

5. The transaction platform for virtual commodities of claim 2, being characterized that, when the buyer performs the transaction on the trade target, the transaction processing component notifies the financial system to perform a credit card payment process, such that the buyer has the financial system receive the transaction payment by using the credit card payment process.

6. The transaction platform for virtual commodities of claim 2, being characterized that, the transaction processing component notifies the financial system to generate a collection barcode at collecting entity, such that the buyer is allowed to fulfill the transaction payment through the collection barcode at the collecting entity to have the financial system receive the transaction payment.

7. The transaction platform for virtual commodities of claim 1, being characterized that, the transaction condition is that the buyer pays a seller-designated transactional commodity in the game system to the seller, the transaction condition is fulfilled when the game system hands over the transactional commodity to the seller, and meanwhile the game system hands over the virtual commodity to the buyer.

8. The transaction platform for virtual commodities of claim 7, being characterized that, the buyer transmits a transaction signal to the game system though the payment verified component to have the game system hand over the transactional commodity to the seller.

9. The transaction platform for virtual commodities of claim 1, being characterized that, the transaction condition is that the buyer pays a seller-designated transactional commodity in another game system to the seller, the transaction condition is fulfilled when the another game system hands over the transactional commodity to the seller, and meanwhile the game system hands over the virtual commodity to the buyer.

10. The transaction platform for virtual commodities of claim 9, being characterized that, the payment verified component transits a transaction signal to the another game system to have the another game system hand over the transactional commodity to the seller.
